(19) United States
(12) Patent Application Publication
(10) Pub. No.: US 2016/0098086 A1
(43) Pub. Date: Apr. 7, 2016

(54) WEARABLE SMART TYPE INPUT AND CONTROL DEVICE

(71) Applicant: CHIEN-WEN LI, Taichung City (TW)

(72) Inventor: CHIEN-WEN LI, Taichung City (TW)

(21) Appl. No.: 14/507,233

(22) Filed: Oct. 6, 2014

(51) Int. Cl. G06F 3/01; G06F 1/16; G06F 3/0488; G06F 3/0354; G01C 19/00; G01P 15/00

(52) U.S. Cl. CPC G06F 3/017; G01C 19/00; G01P 15/00; G06F 3/04886; G06F 3/03547; G06F 1/169; G06F 1/163; G06F 2203/0339; G06F 2203/04104

(57) ABSTRACT

A wearable smart type input and control device comprises a linking transmission module, an orientation recognizing module, an action sensing module, and a message input module. The linking transmission module links a controlled apparatus and transmit information; the orientation recognizing module identifies position, moving speed and direction of the device to obtain a first kind of information; the action sensing module identifies control way such as paging, moving and selecting to obtain a second kind of information; the message input module inputs and edits words and messages to obtain a third kind of information. The first kind of information, the second kind of information, and the third kind of information are operated to control the apparatus and to input the words and messages.

### BACKGROUND OF THE INVENTION

1. Field of the Invention

The present invention relates to an input and control device, and more particularly to a wearable smart type input and control device.

2. Description of Related Art

After versatile digital products being developed, the traditional input and control way becomes impossible to meet requirements of the digital products. Some of reasons are exemplarily listed hereinafter:

1. The traditional keyboard is not easy to carry with and it is necessary to have a flat work stand such as desktop to support the keyboard.

2. The virtual keyboard needs a flat projection plane.

3. Voice input recognition capability is poor and easily affected with the ambient environment such that it is not proper to be operated anywhere.

4. The portable device has a limited space for the screen; keys on the keyboard are very close to each other to be touched inadvertently; looking for the keys individually during operation of the keyboard leads poor input efficiency.

5. Non-touch type screen is incapable of being input and controlled with simple touch.

Although most digital products such as cell phones, tablet personal computers, wearable devices, smart watches, smart bracelets, smart glasses, new types of television, and multimedia televisions are touch control type or remote control type, they are undesirable or improper for use, their screens are small in size, the remote control keys are too close to each other to be touched correctly.

It can be understood from the preceding description that most of the mentioned products have deficiencies and inconvenience in use during operation.

Therefore, how to input conveniently with less mistakes and how to simplify control of are worth us to notice.

### SUMMARY OF THE INVENTION

In order to overcome the preceding deficiencies, the present invention is designed to have a circular structure like a ring or bracelet with features such as being portable, wireless, small, and easy operation. In addition, the present invention is in association with the Bluetooth technology and the smart or digital device, the only thing has to be done by the users is to wave an arm, palm and finger, and operations of controlling the smart device and inputting words or symbols can be performed easily regardless what digital and smart products are used; it is not necessary to contact the screen of the smart device, prepare the keyboard, and seek a work platform, that is, the present invention offers the users to transmit messages or control screen operations swiftly and effectively at anywhere.

### BRIEF DESCRIPTION OF THE DRAWINGS

Further benefits and advantages of the present invention will become apparent after a careful reading of the detailed description with appropriate reference to the accompanying drawings:

FIG. 1 is a block diagram showing modules related to word input of a wearable smart type input and control device according to the present invention.

FIG. 2 is a block diagram showing modules related to control of the wearable smart type input and control device according to the present invention.

FIG. 3 is a block diagram illustrating a preferred embodiment of the input and control device of the wearable smart type input and control device according to the present invention.

FIG. 4 is a perspective view illustrating structural arrangement of the wearable smart type input and control device according to the present invention.

FIGS. 5A to 5C illustrate an example of a screen being controlled and clicked by the touch pad of the wearable smart type input and control device according the present invention which is worn a finger.

FIGS. 6A and 6B illustrate another example of a screen in association with a virtual keyboard thereon being controlled by the wearable smart type input and control device according the present invention.

FIGS. 7A to 7C are similar to FIGS. 5A to 5C to illustrate a further example of a screen in association with a virtual keyboard being controlled by the wearable smart input and control device according the present invention.

FIG. 8 is another perspective view illustrating the wearable smart type input and control device according to the present invention.

### DETAILED DESCRIPTION OF THE INVENTION

Referring to FIGS. 1, 2, and 3, block diagrams of operational processes of the wearable smart type input and control device in accordance with the present invention is illustrated. The wearable smart type input and control device comprises an orientation recognizing module A, an action sensing module B, a message input module C, and a linking transmission module D, wherein the orientation recognizing module A provides a direction sensing unit 10, and a position identifying unit 11; the action sensing module B provides a page sensing unit 12 and a motion sensing unit 13; the message input module C provides a touch sensing unit 14, and an operation assisting unit 15; the linking transmission module D provides a wireless linking unit 16.

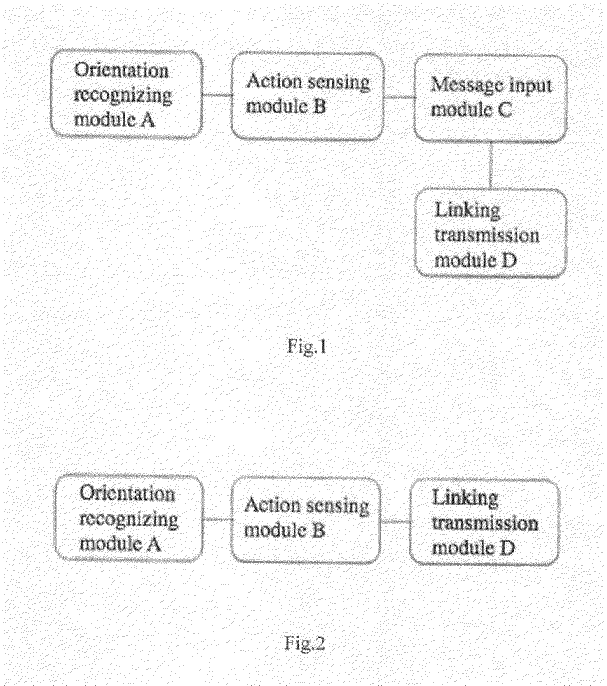

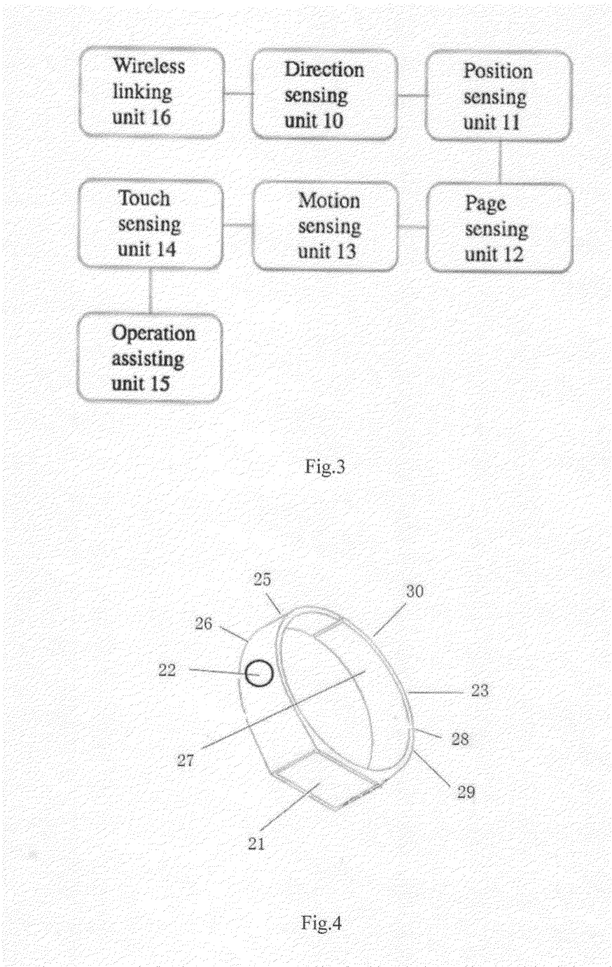

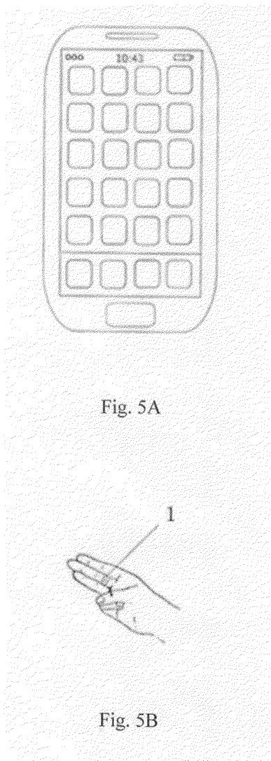

Implementation I: the wireless linking unit 16 of the linking transmission module D is joined to a controlled apparatus, the direction sensing unit 10 and the position identifying unit 11 of the orientation recognizing module A identify the direction and position, and the page sensing unit 12 and the motion sensing unit 13 of the action sensing module B with the touch sensing unit 14 of the message input module C perform page scrolling, selection, and operation. It can be seen in FIGS. 2 and 3 in company with FIG. 4 that when sensors 22, 23 are simultaneously touched to turn on the page sensing unit 12 of the action sensing module B till the selected page of the controlled apparatus appears, then one of the sensors 22, 23 is touched to turn on the motion sensing unit 13 of the action sensing module B till a selected target of the controlled apparatus is reached, the motion sensing unit 13 or the touch sensing unit 14 in the message input module C is touched lightly to complete the selection such that operations for screen control and program selection are performed.

Implementation II: the wireless linking unit 16 of the linking transmission module D is joined to the controlled apparatus, the operation assisting unit 13 of the message input module C is actuated to start up an input mode and a virtual keyboard on the screen; under the circumstances of the input mode and the virtual keyboard in a state of being started up in addition to functions of both the direction sensing unit 10 and the position recognizing unit 11 of the orientation recognizing module A, the page sensing unit 12 of the action sensing module B can be activated to scroll to a selected page on the controlled apparatus as soon as the sensors 22, 23 are touched simultaneously; then a finger is used to touch the touch sensing unit 14 of the message input module C and move to pick characters; after moving to a selected target, the finger is removed from the touch sensing unit 14 to complete the input; afterwards, the operation assisting unit 15 of the message input module C is employed to perform operations such as confirmation, edit, deletion and transmission.

Implementation III: the wireless linking unit 16 of the linking transmission module D is linked to a controlled apparatus, the input mode and the virtual keyboard on the screen are started up via the operation assisting unit 15 of the message input module C, the sensors 22, 23 are touched simultaneously with the direction sensing unit 10 and the position recognizing unit 11 of the direction recognizing module A to switch on the page sensing unit 12 of the action sensing module B till the selected page on the controlled apparatus is reached, one of the sensors 22, 23 is touched to start up the motion sensing unit 13 of the motion sensing module B to move to the selected target, the motion sensing unit 13 or the touch sensing unit 14 of the message input module C is touch lightly to complete operation of character selection, and the operation assisting unit 15 of the message input module C is employed to perform operations such as confirmation, edit, deletion and transmission for information.

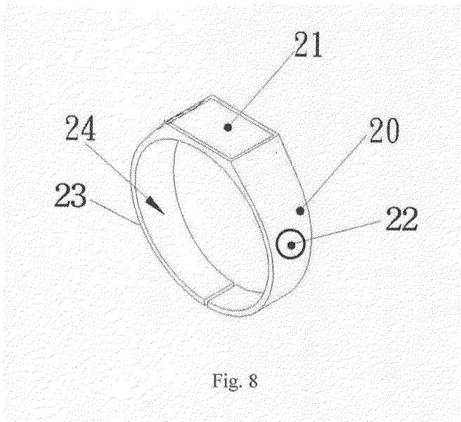

Referring to FIGS. 4 and 8, a preferred embodiment of structural arrangement of the wearable smart type input and control device in accordance with the present invention is illustrated. A ring 20 is designed for fitting with a finger, a touch pad 21 is disposed on the ring 20, the sensors 22, 23 are disposed at two opposite lateral sides of the touch pad 21, and the orientation recognizing module A, the action sensing module B, the message input module C, and the linking transmission module D shown in FIGS. 1 and 2, and a battery 27 are carried by the ring 20. A fitting hole 24 is surrounded by the ring 20 for fitting with the finger. Further, an accelerometer 28, a cyroscope 29, and function keys 30 are also provided on the ring 20, wherein the accelerometer 28 and cyroscope 29 measures moving speed changes and moving directions of the input and control device, respectively, and the function keys 30 are for setting functions of the input and control device of the present invention.

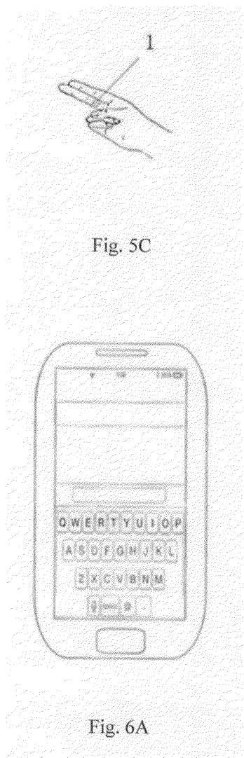

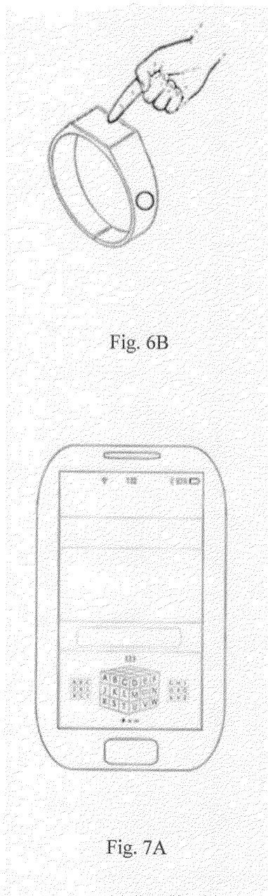

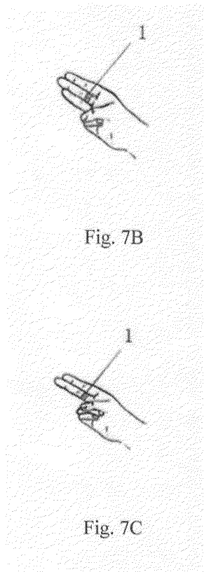

Referring to FIGS. 5A to 5C, 6A and 6B, and FIGS. 7A to 7C in company with FIGS. 3, 4 and 8, exemplary operations of a screen with the input and control device of the present invention are illustrated. The power switch 25 is turned on to start up the direction sensing unit 10 and the position recognizing unit 11 of the direction recognizing module A, and a Bluetooth 26, which acts as the wireless linking unit 16 of the linking transmission module D; the index finger, the middle finger with the input and control device 1, and the ring finger of an operator are closed side by side to touch the sensors 22, 23 simultaneously to actuate the page sensing unit 12 of the action sensing module B till the selected page on the screen is reached; the index finger and the middle finger are closed side by side to touch the one of the sensor 22 or the sensor 23 to actuate the motion sensing unit 13 till the selected target on the screen is reached; the index finger and the middle finger are separated and then closed side by side again to allow the sensor 22 or the sensor 23 being released and touched again or the touch pad 21 is touched lightly to complete the process of selection such that the operations such as the screen control and program click are accomplished.

For another operation way, the power switch 25 is turned on to start up the direction sensing unit 10 and the position recognizing unit 11 of the direction recognizing module A, and the Bluetooth 26 (the wireless linking unit 16) as well; the index finger, middle finger and ring finger of an operator are closed side by side to touch the sensors 22, 23 simultaneously to actuate the page sensing unit 12 of the action sensing module B till the selected page on the screen is reached; a finger is operated on the touch pad 21 to move upward, downward, leftward and rightward to control the virtual keyboard till the selected character is reached to complete the selection or edit, deletion and transmission are performed with the operation assisting unit 15.

For a further operation, the power switch 25 is turned on to start up the direction sensing unit 10 and the position recognizing unit 11 of the direction recognizing module A, and the Bluetooth 26 (the wireless linking unit 16) of the linking transmission module D, and the virtual keyboard on the screen is opened; the index finger, middle finger and ring finger of the operator are closed side by side to touch the sensors 22, 23 simultaneously to actuate the page sensing unit 12 of the action sensing module B till the selected page on the screen is reached; the index finger and the middle finger are closed side by side to touch one of the sensors 22, 23 to actuate the motion sensing unit 13 till the selected target on the screen is reached; the index finger and the middle finger are separated and then closed side by side again to allow one of the sensors 22, 23 being released and touched again or the touch pad 21 is touched lightly to complete the process of selection, or edit, deletion and transmission are performed with the operation assisting unit 15.

Although the invention has been explained in relation to the preferred embodiments, it is to be understood that other possible modifications and variations can be made without departing from the spirit and scope of the invention as hereinafter claimed.

What is claimed is:

1. A wearable smart type input and control device, which is worn on a finger or a wrist to control an apparatus and input words and messages with motions of fingers, a palm or the wrist, comprising:
a linking transmission module to link said controlled apparatus for information capable of being transmitted to the controlled apparatus;
an orientation recognizing module to identify position, moving speed and direction of the device to obtain a first kind of information;
an action sensing module to identify control way of a user such as paging, moving and selecting to obtain a second kind of information, wherein the action sensing module has a page sensing unit and a motion sensing unit;
a message input module to input and edit words and messages to obtain a third kind of information;
wherein the device has two sensors, the two sensors are touched simultaneously to start up said page sensing unit, and one of the sensors is touched to start up the motion sensing unit so as to obtain the second information;
wherein, the first kind of information, the second kind of information, and the third kind of information are operated to control the apparatus and to input the words and messages.

2. The wearable smart type input and control device as defined in claim 1, wherein the linking transmission module further comprises a wireless linking unit to link the controlled apparatus wirelessly.

3. The wearable smart type input and control device as defined in claim 1, wherein the orientation recognizing module further comprises a direction sensing unit, and a position identifying unit; the direction sensing unit is capable of identifying moving direction and speed information of the device, and the position identifying unit is capable of distinguishing information related to an initial position and a terminal position.

4. The wearable smart type input and control device as defined in claim 1, wherein the page sensing unit in association with information of the moving direction and speed, and the information related to the initial position and the terminal position is capable of controlling paging and moving of a screen on the apparatus in accordance with motions of the wrist, palm or finger; the motion sensing unit is capable of controlling motion of a cursor and selection of content on the screen.

5. The wearable smart type input and control device as defined in claim 1, wherein the two sensors are disposed at two opposite sides of the device respectively, the two sensors are operated to actuate the page sensing unit and the motion sensing unit and differentiate function and operation of the page sensing unit from the motion sensing unit.

6. The wearable smart type input and control device as defined in claim 1, wherein the message input module further comprises a touch sensing unit and an operation assisting unit; the touch sensing unit has a touch pad to receive slid information and picked information of character done by the finger; the operation assisting unit is employed to complete inputs of the words and the messages.

7. The wearable smart type input and control device as defined in claim 1 further comprising a ring and a fitting hole wherein the ring loads said orientation recognizing module, said action sensing module, said message input module, said linking transmission module, and a battery; said the fitting hole is for the ring being worn on the finger or wrist, and motions of the finger or wrist are capable of controlling the apparatus and operating inputs of the words and messages.
